(19) United States
(12) Patent Application Publication
(10) Pub. No.: US 2019/0025585 A1
(43) Pub. Date: Jan. 24, 2019

(54) WEARABLE DEVICE AND CONTROL METHOD FOR WEARABLE DEVICE

(71) Applicant: Olympus Corporation, Tokyo (JP)

(72) Inventors: Tatsuyuki UEMURA, Tachikawa-shi (JP); Yoji Osanai, Hachioji-shi (JP); Kazuhiko SHIMURA, Hachioji-Shi (JP); Kazuo KANDA, Higashiyamato-shi (JP); Yoshiyuki Fukuya, Sagamihara-shi (JP); Kazuhiko Osa, Hachioji-shi (JP); Osamu NONAKA, Sagamihara-shi (JP)

(21) Appl. No.: 16/033,183

(22) Filed: Jul. 11, 2018

(30) Foreign Application Priority Data
Jul. 18, 2017 (JP) 2017-139105

(51) Int. Cl. G02B 27/01; G06F 3/01

(52) U.S. Cl. CPC G02B 27/017; G06F 1/163; G06F 3/011

(57) ABSTRACT

A wearable device includes a display element, a display part and a storage device. The display element displays an image based on an image signal. The display part is configured to be arranged in front of an eye of wearer, has a narrower display region than a visual field of the wearer, and displays the image displayed on the display element and guided by a light guiding optical system. The storage device stores a positional relationship between an operation visual field as a visual field of the wearer in performing an operation, and the display region of the display part arranged in front of the eye.

### CROSS-REFERENCE TO RELATED APPLICATIONS

This application is based upon and claims the benefit of priority from prior Japanese Patent Application No. 2017-139105, filed Jul. 18, 2017, the entire contents of which are incorporated herein by reference.

### BACKGROUND OF THE INVENTION

### 1. Field of the Invention

The present invention relates to a wearable device and a control method for the wearable device.

### 2. Description of the Related Art

Wearable devices have been known, in which a display part is arranged in front of wearer's eyes so that a screen is displayed to the wearer. In particular, a wearable device configured to enable a wearer to simultaneously view both the real world and an image displayed on the wearable device has been known. The technique relating to such a wearable device is disclosed in, for example, Jpn. Pat. Appln. KOKAI Publication No. 2017-22668. This document discloses the technique for enabling a wearer to adjust a position of a display part of a wearable device.

### BRIEF SUMMARY OF THE INVENTION

According to an aspect of an invention, a wearable device includes a display element that displays an image based on an image signal; a display part that is configured to be arranged in front of an eye of wearer, has a narrower display region than a visual field of the wearer, and displays the image displayed on the display element and guided by a light guiding optical system; and a storage device that stores a positional relationship between an operation visual field as a visual field of the wearer in performing an operation, and the display region of the display part arranged in front of the eye.

According to an aspect of an invention, a control method for a wearable device includes displaying an image based on an image signal on a display part that is configured to be arranged in front of an eye of wearer, and has a narrower display region than a visual field of the wearer; and storing a positional relationship between an operation visual field as a visual field of the wearer in performing an operation, and the display region of the display part arranged in front of the eye.

Advantages of the invention will be set forth in the description which follows, and in part will be obvious from the description, or may be learned by practice of the invention. The advantages of the invention may be realized and acquired by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an external view showing an example of a configuration of a wearable device according to an embodiment;

FIG. 2 is a block diagram showing an example of a configuration of a system including the wearable device according to the embodiment;

FIG. 3 is a schematic diagram for illustrating a line of sight of a wearer and both a display region and an imaging region of the wearable device;

FIG. 4 is a schematic diagram for illustrating a line of sight of a wearer and both a display region and an imaging region of the wearable device;

FIG. 5 is a schematic diagram for illustrating a line of sight of a wearer and both a display region and an imaging region of the wearable device;

FIG. 6 is a flowchart showing an outline of an example of an operation of the wearable device according to the embodiment;

FIG. 7 is a flowchart showing an example of an outline of calibration processing of the wearable device according to the embodiment;

FIG. 8 is a schematic diagram for illustrating a relation between an operation visual field of a wearer and the imaging region of the wearable device during calibration processing;

FIG. 9 is a schematic diagram for illustrating a relation between an operation visual field of a wearer and the display region of the wearable device during calibration processing;

FIG. 10 is a schematic diagram for illustrating a relation between an operation visual field of a wearer and the display region of the wearable device during calibration processing;

FIG. 11 is a flowchart showing an outline of an example of an operation of a wearable device according to a first example;

FIG. 12 is a schematic diagram for illustrating a relation between an operation visual field of a wearer and a display region of the wearable device during operation according to the first example;

FIG. 13 is a flowchart showing an outline of an example of an operation of a wearable device according to a second example;

FIG. 14 is a flowchart showing an outline of an example of an operation of a server according to the second example;

FIG. 15 is a schematic view for illustrating a usage state of a wearable device according to a third example;

FIG. 16 is a flowchart showing an outline of an example of an operation of an information terminal according to the third example;

FIG. 17 is a flowchart showing an outline of an example of an operation of a wearable device according to a fourth example; and

FIG. 18 is a schematic diagram for illustrating a relation between an operation visual field of a wearer and both a display region and an imaging region of the wearable device during operation according to the fourth example.

### DETAILED DESCRIPTION OF THE INVENTION

An embodiment of the present invention will be described with reference to the drawings. The present embodiment relates to an eyeglass-type wearable device including a display element and a camera. A wearable device of this type may be network-connected to various devices to establish a system therewith.

When such a wearable device is worn, a display part of the wearable device may be arranged in a different position of a visual field for each wearer and for each time of usage. Information relevant to a positional relationship between a visual field of a wearer and a display region of a wearable device is useful.

An object of the present embodiment is to provide a wearable device containing information on a positional relationship between a visual field of a wearer and a display region of the wearable device, and a control method for the wearable device.

<Configuration of System>

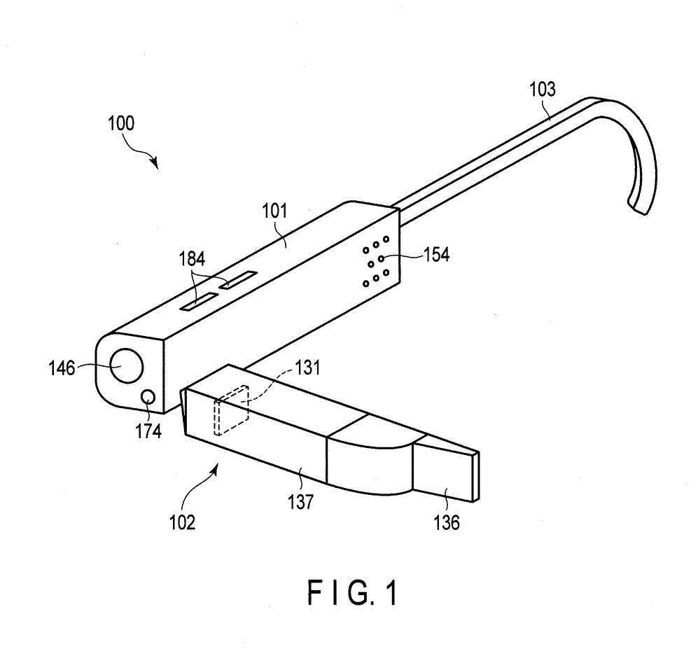

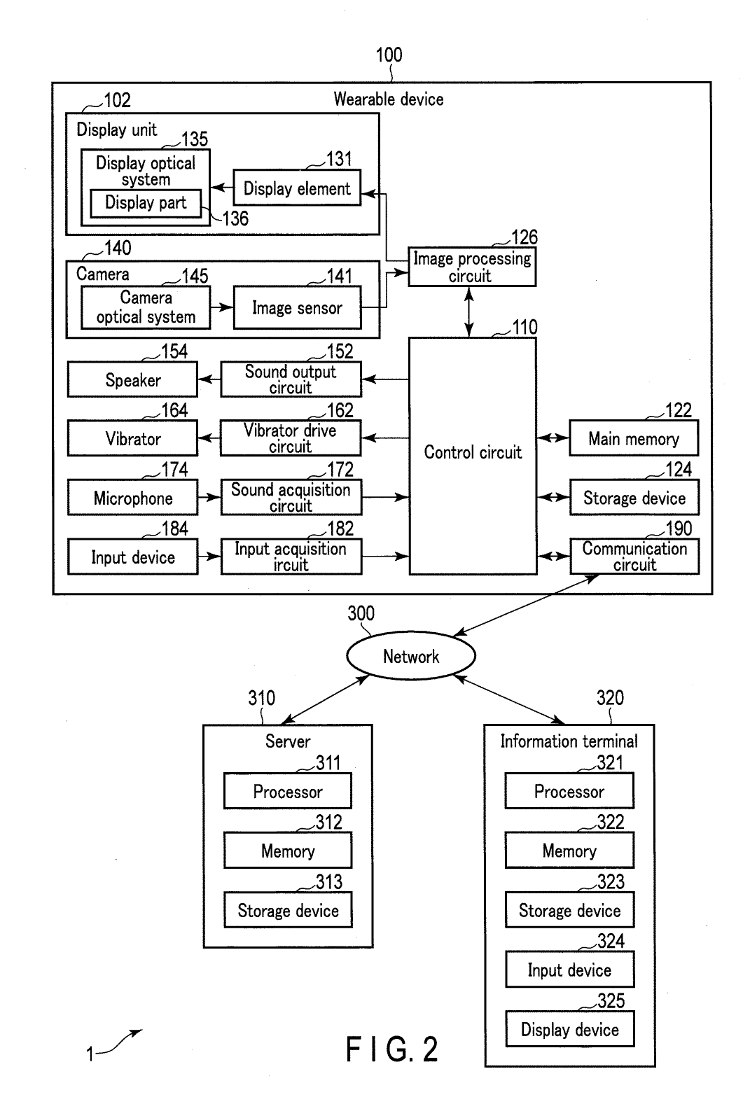

FIG. 1 shows the appearance of a wearable device 100 according to the present embodiment. FIG. 2 shows an example of a configuration of a system 1 including the wearable device 100. As shown in FIG. 1, the wearable device 100 is an eyeglass-type terminal. The wearable device 100 includes a body 101, a display unit 102, and a temple 103. The body 101 is to be arranged on a lateral side of a user's face. The display unit 102 extends from the body 101 to a front side of the user's face. The temple 103 that extends from the body 101 is to be hooked behind the user's ear.

The display unit 102 includes a display element 131 such as a liquid crystal display, an organic EL display, etc. An image displayed on the display element 131 based on an image signal is guided by a light guiding unit 137 to a display part 136. As a result, the image is displayed on the display part 136. As described above, a display optical system 135 includes an optical system of the light guiding unit 137 and the display part 136. A user hooks the temple 103 behind his or her ear so that the display part 136 is arranged in front of the user's eyes. In this manner, the user can view an image displayed on the display part 136. In the display part 136, a display region in which an image is displayed on the display part 136 is narrower than a visual field of a wearer. The narrowness is not important for viewing of a large screen but contributes to downsizing. In addition, when a wearer is viewing the outside of a screen, a narrow display region does not hinder the wearer's activities by blocking his or her visual field. This is an important advantage of the narrowness.

The wearable device 100 adopts an optical system called a pupil-division optical system in which the display part 136 is smaller in size than the pupil diameter. Accordingly, a user wearing the wearable device 100 can view a scene behind the display part 136. That is, the wearable device 100 enables the user to view the display part 136 only when necessary.

The body 101 is provided with a camera 140 to enable imaging in a direction of the user's line of sight. Therefore, the body 101 is provided with an objective lens 146 arranged in a manner to bring its optical axis approximately in line with the direction of a user's line of sight. A camera optical system 145 including the objective lens 146 forms an image of a subject on an imaging surface of an image sensor 141. It is preferable that a visual field of a user be covered by a visual field of the camera 140. A too wide view angle may reduce the resolution, whereas a narrow view angle is prone to cause overlooking. The effective design for checking a condition, etc. is setting a view angle in a manner to cover a full range of a user's view even with the user's eyes moving. To satisfy those various conditions, a plurality of cameras, a zoom optical system, etc. may be used.

This embodiment has been considered from the aspect of no change in the camera 140 or the display part 136 of a wearable device, apparatus, or terminal in a state of being worn, whereas a condition of the user's eyes changes due to eye movement. That is, the user is able to have various reactions hands-free, such as freely changing the direction of a line of sight or a focus position by moving the user's eyes. On the other hand, a device is limited in flexibility. Furthermore, a user tends to fix his or her eyes in a specific direction when performing some operation. A visual field of a user when performing an operation is referred to as an operation visual field. At this time, the design to prevent the display part 136 from blocking the user's visual field brings about a situation where the user cannot view a displayed content unless he or she consciously moves their eyes in the direction of viewing the display part 136. The display part 136 can display content which is hard to convey or hear by sound. Much of the displayed content is important in information transmission. Accordingly, there is a demand for a technique to urge a user to view this display part 136. How much an operation visual field and an expected visual field of the display part 136 are displaced from each other depends on individual differences, an environment, conditions, etc. It is important to take measures for making a correct determination of such individual differences, an environment, conditions, etc.

The body 101 is provided with a microphone 174 configured to pick up external sound, and a speaker 154 configured to output sound. The body 101 is further provided with an input device 184 such as a button switch.

A configuration of the wearable device 100 will be further described with reference to FIG. 2. The wearable device 100 includes a control circuit 110, a main memory 122, a storage device 124, and an image processing circuit 126. The control circuit 110 controls operation of respective units of the wearable device 100. The main memory 122 includes an area for use in computation of the control circuit 110. The storage device 124 stores various types of information such as programs, various types of necessary information for use in the control circuit 110, images acquired by a camera, etc. The image processing circuit 126 processes images such as an image to be displayed on the display element 131, an image acquired by the camera 140, etc.

The control circuit 110 and the image processing circuit 126 may include, for example, a central processing unit (CPU), an application specific integrated circuit (ASIC), a field programmable gate array (FPGA), a graphics processing unit (GPU), etc. The control circuit 110 and the image processing circuit 126 may be each formed of, for example, a single integrated circuit or a combination of integrated circuits. Alternatively, the control circuit 110 and the image processing circuit 126 may be collectively formed of a single integrated circuit. In addition, semiconductor memories of various types may be used as the main memory 122 and the storage device 124.

Under the control of the control circuit 110, an image to be displayed on the display part 136 is processed for display by the image processing circuit 126, and is displayed on the display element 131 by a driving circuit (not shown). An image displayed on the display element 131 is displayed using the display optical system 135. That is, the image is displayed on the display part 136 through the light guiding unit 137.

An image of a subject entered to the camera optical system 145 including the objective lens 146 is captured by the image sensor 141 that is operated by the driving circuit (not shown) under the control of the control circuit 110. The shot image acquired by the image sensor 141 is processed by the image processing circuit 126. This processed image is then, for example, used for analysis, displayed on the display part 136, or stored in the storage device 124, as appropriate.

The wearable device 100 includes a sound output circuit 152 and the aforementioned speaker 154 in order to output sound under the control of the control circuit 110. The sound output circuit 152 drives the speaker 154 to output necessary sounds therefrom under the control of the control circuit 110.

The wearable device 100 may use vibrations other than sound to transmit information to a wearer. For this purpose, the wearable device 100 includes a vibrator drive circuit 162 and a vibrator 164. The vibrator drive circuit 162 transmits information to a wearer by vibrating the vibrator 164 under the control of the control circuit 110.

The wearable device 100 includes a sound acquisition circuit 172 and the aforementioned microphone 174 in order to acquire external sounds. The sound acquisition circuit 172 generates a sound signal based on sounds picked up by the microphone 174, thereby transmitting this signal to the control circuit 110. However, sound communication becomes difficult under loud environments, etc. For this reason, displayed information is important.

To receive instructions from a user such as a wearer, the wearable device 100 includes an input acquisition circuit 182 and the input device 184 including the aforementioned button switch. The input device 184 may include various sensors, a knob, a slider, etc. The input acquisition circuit 182 generates an input signal based on an input to the input device 184, thereby transmitting this signal to the control circuit 110.

The wearable device 100 may communicate with other external devices. Therefore, the wearable device 100 includes a communication circuit 190. The communication circuit 190 communicates with other devices outside the wearable device 100 by wireless communication such as Wi-Fi or Bluetooth, or by wired communication.

The wearable device 100 communicates with, for example, various servers 310, an information terminal 320 including, e.g., a personal computer (PC) via a network 300, etc., thereby forming the overall system 1. The wearable device 100 and various external devices may be directly connected to each other without using the network 300. The server 310 performs various types of information processing and includes, for example, a processor 311, a memory 312, and a storage device 313. The information terminal 320 shares information with a person who wears the wearable device 100, or is used by a person who gives an instruction to the person wearing the wearable device 100. The information terminal 320 includes, for example, a processor 321, a memory 322, a storage device 323, an input device 324, a display device 325, etc.

<Display Region and Imaging Region of Wearable Device>

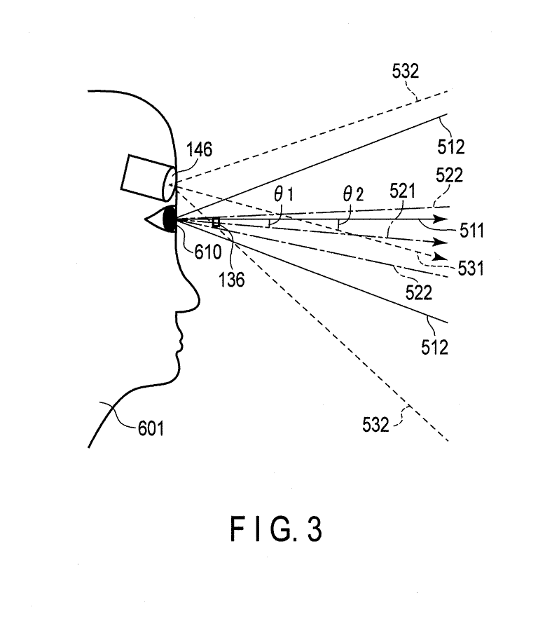

Described below is a relationship between a display region and an imaging region of the wearable device 100 according to the present embodiment, a visual field of a wearer, etc. FIG. 3 schematically illustrates the display region and the imaging region of the wearable device 100. Furthermore, FIG. 3 schematically illustrates a visual field of a wearer 601. The display part 136 is arranged in front of eyes 610 of the wearer 601. The camera 140 including the objective lens 146 is fixed with respect to the face of the wearer 601. While the wearer 601 performs an operation, his or her line of sight faces the direction shown by a solid-line arrow 511. At this time, a visual field of the wearer 601 falls within a range indicated by two solid lines 512. This visual field is referred to as an operation visual field. The display part 136 of the wearable device 100 is arranged inside an operation visual field of the wearer 601. The direction indicated by the dashed-dotted-line arrow 521 presents the direction of the line of sight when the wearer 601 views the center of the display part 136. What is displayed by the display part 136 is viewable within a range indicated by the two dashed-dotted lines 522 inside an operation visual field. A region in which what is displayed by the display part 136 is viewable is referred to as a display region. A broken-line arrow 531 presents the optical axis of the camera optical system 145 of the wearable device 100. A region to be shot by the camera 140 via the camera optical system 145 falls within the region indicated by two broken lines 532. A region to be shot via the camera optical system 145 is referred to as an imaging region.

As described above, in the present embodiment, the line of sight of the wearer 601, presented by the solid-line arrow 511, the center of the display part 136, presented by the dashed-dotted-line arrow 521, and the optical axis of the camera optical system 145, presented by the broken-line arrow 531, are different from each other. That is, there is parallax θ1 between the line of sight in an operation visual field of the wearer 601 and the line of sight when the wearer 601 views the display part 136. There is another parallax θ2 between the line of sight in an operation visual field of the wearer 601 and the optical axis of the camera 140. As described above, there are two parallaxes when the line of sight in an operation visual field of the wearer 601 is used as a reference. In addition, there is a parallax between the line of sight when the wearer 601 views the display part 136 and the optical axis of the camera 140. As described above, various parallaxes need to be considered in the present embodiment.

In addition, the operation visual field presented by the solid line 512, the display region presented by the dashed-dotted line 522, and the imaging region presented by the broken line 532 are different from each other. Once a distance to a subject to be focused is determined, a range of the operation visual field presented by the solid line 512, a range of the display region presented by the dashed-dotted line 522, and a range of the imaging region presented by the broken line 532 are to be determined on the plane where the subject exists.

Furthermore, a relationship between the operation visual field, the display region, and the imaging region is different according to a line of sight of a wearer 601, etc. which depends on how the wearer 601 wears the wearable device 100 and what type of operation the wearer 601 performs. For example, regarding a position to arrange the display region in the operation visual field, an optimum position for facilitating execution of an operation may be different depending on a type of such an operation. In addition, even if the wearer 601 wears the wearable device 100 in a similar manner, the height of the line of sight is different for each operation, so that the display region with respect to the operation visual field may be different. The wearer 601 may be a person who prefers the display region positioned close to the center of the operation visual field, or may be a person who prefers the display region positioned in the corner of the operation visual field. The way of wearing the wearable device 100 may be different according to a wearer's taste.

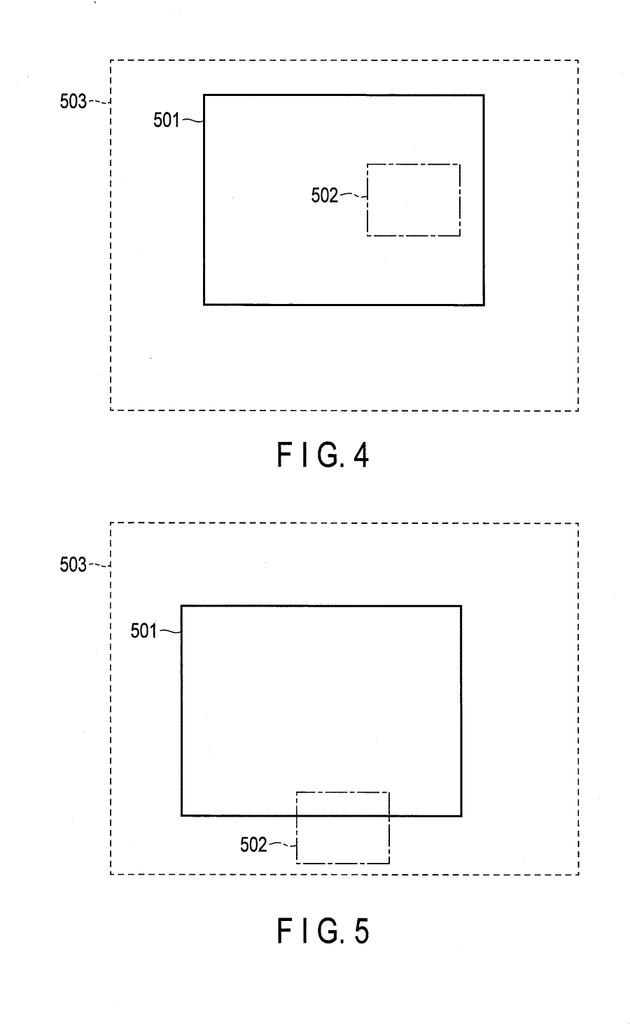

FIGS. 4 and 5 show the examples of a relation between the operation visual field, the display region, and the imaging region. In each of the drawings, the solid line, the dashed-dotted line, and the broken line present an operation visual field 501, a display region 502, and an imaging region 503, respectively. Their positional relationship may change. Their positional relationship is different between FIG. 4 and FIG. 5. In the example shown in FIG. 4, the operation visual field 501 is positioned inside the imaging region 503, and the display region 502 is positioned inside the operation visual field 501. In this case, an image displayed on the display part 136 comes in the visual field of the wearer 601 who is performing an operation. On the other hand, in the example shown in FIG. 5, the operation visual field 501 is positioned inside the imaging region 503; however, only a part of the display region 502 is positioned inside the operation visual field 501. In this case, only a part of the image displayed on the display part 136 comes into the visual field of the wearer 601 who is performing an operation.

<Operation of Wearable Device>

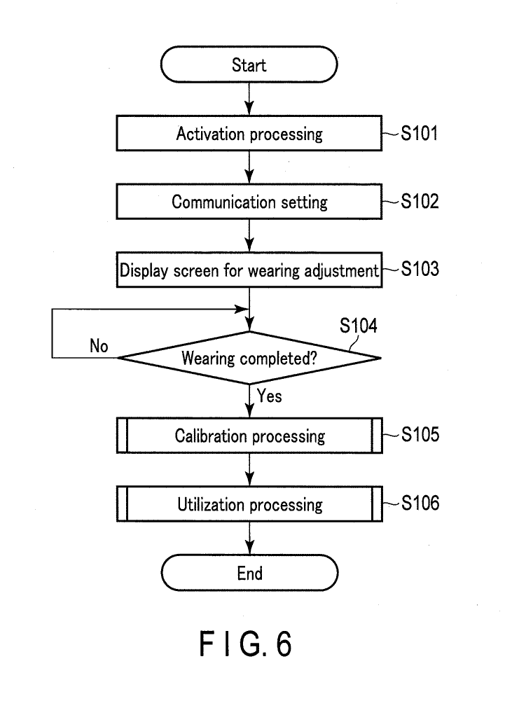

The operation of the wearable device 100 will be described with reference to the flowchart shown in FIG. 6. This processing is initiated when a power-source switch of the wearable device 100 is switched to ON.

In step S101, the control circuit 110 performs activation processing. For example, the control circuit 110 initiates power supply from a power source (not shown) to respective units, thereby activating programs to perform various initiation settings.

In step S102, the control circuit 110 performs communication setting. That is, the control circuit 110 establishes connection with an external network or device as needed.

In step S103, the control circuit 110 causes the display element 131 to display a screen for the wearing adjustment. The wearer 601 wears the wearable device 100 and adjusts a wearing position while viewing the screen for the wearing adjustment displayed on the display element 131 via the display part 136.

In step S104, the control circuit 110 determines whether or not the wearer 601 has finished putting on the wearable device 100. It is determined that the wearer 601 has finished putting on the wearable device 100, for example, when a switch indicative of completion of putting on is switched, when a sensor (not shown) that detects completion of putting on detects completion of putting on, or when the wearer 601 states completion of putting on and his or her speech is acquired by the microphone 174 and recognized. The processing waits until putting on is completed. The processing proceeds to step S105 when putting on is completed.

In step S105, the control circuit 110 performs calibration processing. The calibration processing is to acquire and record the aforementioned positional relationship between the operation visual field 501, the display region 502, and the imaging region 503. The positional relationship recorded herein is used in subsequent processing. The calibration processing will be described in detail later. When the calibration processing is completed, the processing proceeds to step S106.

In step S106, the control circuit 110 performs utilization processing. The utilization processing is to, for example, present an image or the like to the wearer 601 as usage, and to acquire an image in the direction of the line of sight of the wearer 601. The utilization processing is for the wearable device 100 to fulfill its functions. When the purpose of an operation performed by the wearer 601, etc. is achieved and the utilization processing is completed, the operation of this wearable device 100 is terminated.

<Calibration Processing>

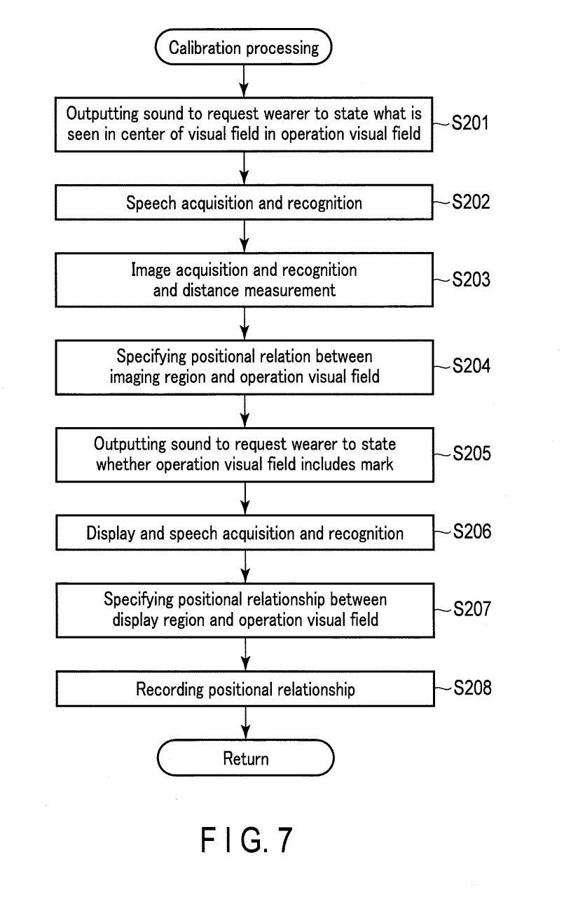

The calibration processing is explained with reference to the flowchart shown in FIG. 7.

In step S201, the control circuit 110 causes the speaker 154 to output a sound requesting the wearer 601 to acquire the line of sight for performing an operation and to state what is seen in the center of the visual field at that time. In step S202, the control circuit 110 acquires a speech uttered by the wearer 601 via the microphone 174, and performs speech recognition processing with respect to the acquired speech.

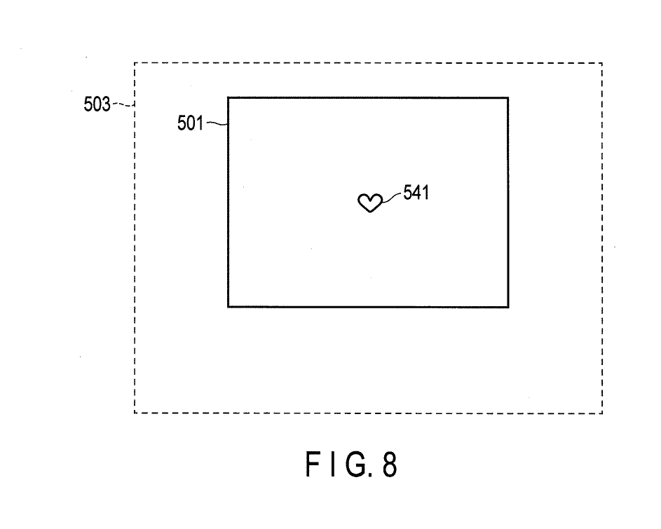

For example, as shown in FIG. 8, when a heart mark 541 is seen in the center of the operation visual field 501, the wearer 601 pronounces “heart” based on instructions given by the wearable device 100 via the speaker 154. The control circuit 110 acquires this speech via the microphone 174 and recognizes that the wearer 601 has pronounced “heart”.

In step S203, the control circuit 110 causes the camera 140 to acquire an image. The image processing circuit 126 analyzes the image acquired by the camera 140. The image processing circuit 126 specifies a position of a subject present in the center of the operation visual field 501 of the wearer 601 who is recognized in step S202. In the example shown in FIG. 8, for example, the image processing circuit 126 searches for the heart mark 541 and specifies its position. The control circuit 110 measures a distance to a subject present in the center of the operation visual field 501. This distance may be measured using a range finding means such as an infrared range finder (not shown), or may be performed using a focal point of the camera optical system 145.

In step S204, the control circuit 110 specifies a positional relationship between the operation visual field 501 of the wearer 601 and the imaging region 503 for the camera 140, using information on a distance to a subject present in the center of the operation visual field 501. An angle generally usable for a visual field taken when performing an operation is known. Thus, once a distance is acquired, the width of a visual field taken when performing an operation, that is, the operation visual field 501, can be specified. A view angle of the camera 140 is also known. Therefore, once a distance is acquired, the imaging region 503 for the camera 140 can be specified. As a result, a positional relationship between the operation visual field 501 and the imaging region 503 can be specified. Specifying a position may be performed in not only the center of the operation visual field 501, but also the other parts. However, information indicative of a position of which part in the operation visual field 501 is specified is necessary. The above description has assumed the example where information on a subject, a position of which is specified, is input to the wearable device 100 by speech uttered by the wearer 601 but is not limited to this. Information on a subject, a position of which is specified, may be input by other methods such as the input device 184.

Furthermore, information transmission to the wearer 601 is not necessarily limited to speech, and may be a display, etc. As a notification to the wearer 601, a guide message “enter what you see in front (an image feature such as a name, shape, or color that is different between the front and the others)” is displayed. The wearer 601 gives a reply to this guide message. A reply may be given via speech input, keyboard input, touch input, etc. Based on a given reply, the control circuit 110 or the image processing circuit 126 detects a corresponding image feature from an image acquired by the camera 140. Based on the detected image feature, the control circuit 110 or the image processing circuit 126 determines which part of the imaging region 503 for the camera 140 corresponds to the approximate center of the operation visual field 501 of the wearer 601. The guide message in the above example presents “what you see”. However, if a guide message presents “what you see in the line-of-sight direction during operation”, the control circuit 110 or the image processing circuit 126 is able to determine which part of the imaging region 503 corresponds to the operation visual field. As a result, information on a parallax between the operation visual field 501 and the imaging region 503 of the worn camera 140 can be acquired. This parallax corresponds to the parallax θ2 between the line of sight in an operation visual field of the wearer 601, presented by the solid-line arrow 511, and the optical axis of the camera 140, presented by the broken-line arrow 531.

What is seen inside the imaging region 503 may be, for example, an image projected by a projector or the like. The above example uses the word “center” for the simplification of instructions and replies. However, a parallax between an operation visual field and an imaging visual field may be acquired based on a reply such as “I see the mark on the right side obliquely upward on the center”. Herein, a parallax may be a positional difference between an operation visual field and an imaging visual field, a difference between an operation visual field and a camera direction, or an angular difference between an operation visual field and a camera direction. An operation visual field is a visible range corresponding to a view angle of a camera. An operation visual field may be determined using a value for people in general, or a value for each individual person.

Furthermore, a speech guide or display presenting “enter what you see in front” is not essential. Without such a guide, a parallax may automatically be detected when the word “see” is used in combination with any word describing an image feature. That is, when the wearer 601 is taking an operation visual field, the image processing circuit 126 (in particular, an operation visual field-imaging region specifying unit) acquires feature information on a subject which the wearer 601 sees in a specific position inside the operation visual field 501, via, e.g., speech, input of characters, or touch operation. The image processing circuit 126 specifies, by image recognition, a position corresponding to the acquired feature information inside the imaging region 503 with respect to an image acquired by the camera 140. In this manner, the image processing circuit 126 can specify a positional relationship between the operation visual field 501 and the imaging region 503. This requires a comparison between input of a feature visually observed and a feature acquired by an image determination. Such a comparison may use a database in which a general-use word (text) and an image feature are associated. For example, in this database, a certain mark is associated with the word “heart”, and a certain part of a certain shape is associated with the phrase “angle at the lower right of a triangle”. The database may be updated by learning. A position of an image may, of course, be specified by a touch operation, instead of by text input. In this case, a database of relationships between texts and images is not required. The wearable device 100 includes a recording unit for storing a parallax or a positional relationship, etc. of visual fields specified by the aforementioned comparison. When a determination is made during an operation, this recording unit prevents the wearable device 100 from making a false detection due to the presence of a parallax.

As described above, when the wearer 601 is acquiring the operation visual field 501, the image processing circuit 126 functions as an image processing circuit configured to: acquire information on a subject that the wearer 601 sees in a specific position inside the operation visual field 501; and to specify a position of this subject inside the imaging region 503 by image recognition with respect to an image shot and acquired by the camera 140. Furthermore, the control circuit 110 functions as an operation visual field-imaging region specifying unit configured to: specify the operation visual field 501 in an image based on a position of a subject and the size of the operation visual field 501; and specify a positional relationship between the operation visual field 501 and the imaging region 503.

For example, a positional relationship between the operation visual field 501 and the imaging region 503 is specified as shown in FIG. 8. Alternatively, such a positional relationship may be presented by information on a direction of a line of sight and a range of a visual field, and information on a direction of the optical axis of the camera optical system 145 and a view angle of the camera optical system 145, as shown in FIG. 3.

The above description has assumed the example where the wearer 601 states what is seen in the center of the visual field but is not limited to this. The wearer 601 may state what is seen in four corners of the visual field, instead of the center thereof, so that the image processing circuit 126 specifies positions of subjects in the four corners, by image recognition. In this case, in the imaging region 503, that is, in an image acquired by the camera 140, a region whose four corners are set to the specified positions indicates the operation visual field 501. Based on the above, the operation visual field 501 and the imaging region 503 may be specified. This is not limited to the four corners, and the same applies to the case where positions of two subjects in the opposing corners are specified.

As described above, the control circuit 110 functions as an operation visual field-imaging region specifying unit configured to: specify a plurality of positions as positions of subjects which indicate the operation visual field 501; specify the operation visual field 501 in an image based on this plurality of positions; and specify a positional relationship between the operation visual field 501 and the imaging region 503.

The invention is not limited to specifying the operation visual field 501 based on a position of any subject that the wearer 601 has seen. For example, a chart may be used to calibrate a positional relationship between the operation visual field 501 and the imaging region 503. For example, the wearer 601 may arrange predetermined marks in four corners of the operation visual field 501 so that the image processing circuit 126 specifies positions of these markers in an image shot by the camera 140. In those examples, the image processing circuit 126 is only required to recognize a predetermined image.

In step S205, the control circuit 110 causes the speaker 154 to output a sound requesting the wearer 601 to state whether marks displayed on the display part 136 are included in the operation visual field. In step S206, the control circuit 110 causes the display element 131 to display the marks while changing their positions. Furthermore, the control circuit 110 acquires speech uttered at this time by a user through the microphone 174, and performs speech recognition processing.

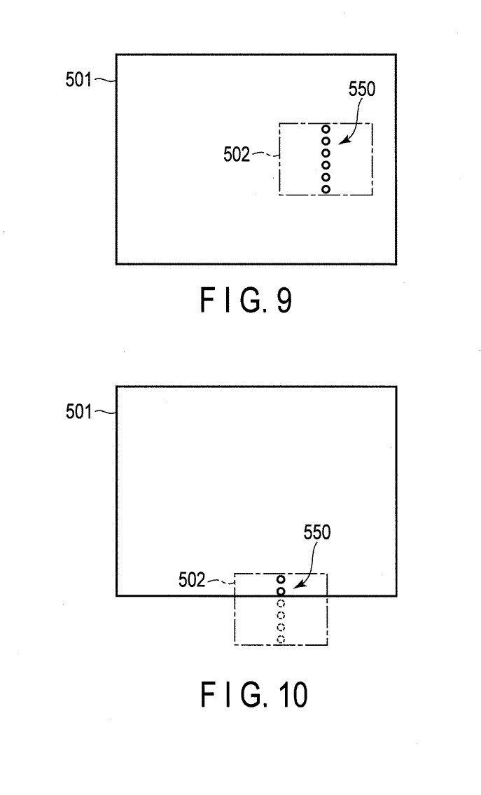

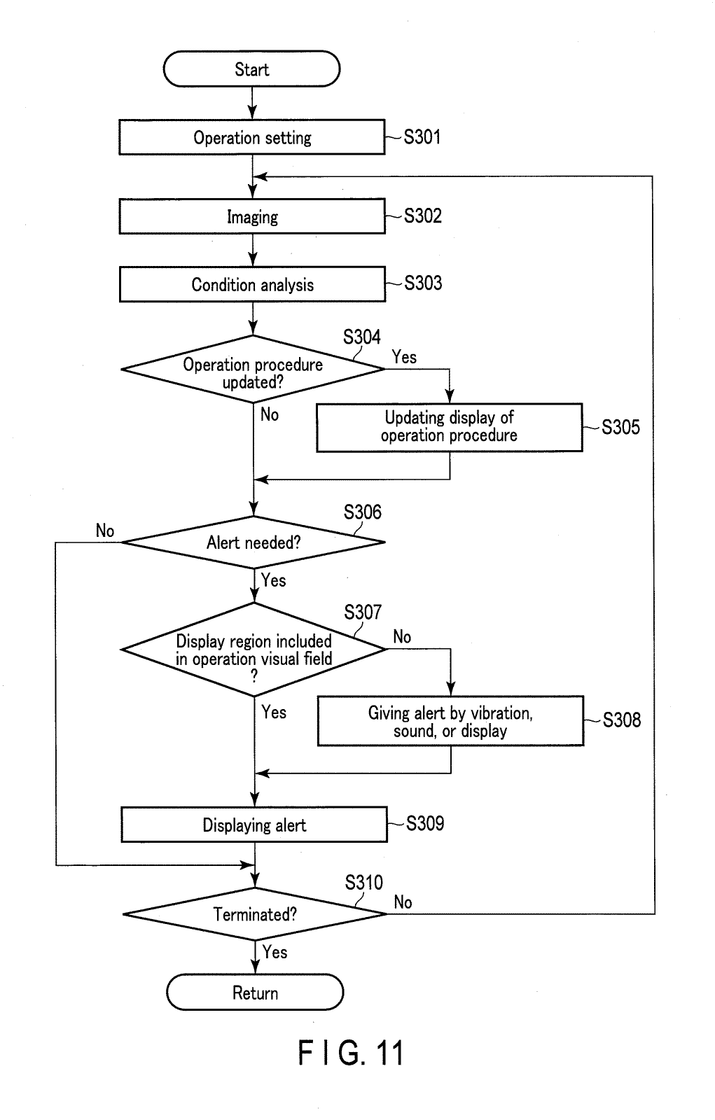

For example, as shown in FIG. 9, marks 550 are sequentially displayed while changing their positions inside the display region 502. The wearer 601 states whether the displayed marks are included in the operation visual field 501. In the example shown in FIG. 9, the display region 502 is entirely included in the operation visual field 501. Thus, regardless of where the marks 550 are displayed in the display region 502, the wearer 601 states that the marks are included in the operation visual field 501.

On the other hand, in the case where the operation visual field 501 and the display region 502 have a positional relationship such as shown in FIG. 10, only the upside of the display region 502 is partially included in the operation visual field 501. Therefore, the marks 550 are sequentially displayed from the downside to the upside of, for example, the display region 502. In this case, the wearer 601 initially states that the operation visual field 501 includes no mark. Then, when a display position of any mark comes into the operation visual field 501, the wearer 601 states this fact.

In step S207, the control circuit 110 specifies a part of the display region 502, which is positioned inside the operation visual field 501, based on a result of speech recognition and a display position of a mark at that time. Based on this part, the control circuit 110 specifies positions of the display region 502 and the operation visual field 501, thereby specifying a positional relationship between the operation visual field 501 and the display region 502. When the display region 502 is entirely included in the operation visual field 501, a position of the display region 502 in the operation visual field 501 is not necessarily determined for a positional relationship. For a positional relationship, information that the display region 502 is entirely included in the operation visual field 501 may be specified. The above description has assumed the example where information regarding whether or not displayed marks are included in the operation visual field 501 is input to the wearable device 100 by speech uttered by the wearer 601, but is not limited to this. This information may be input by other methods such as the input device 184.

As described above, the control circuit 110 functions as an operation visual field-display region specifying unit configured to: control a display on the display part 136; cause the display part 136 to sequentially present predetermined displays in different positions; sequentially acquire results of determinations by the wearer 601 regarding whether or not a display on each part of the display part 136 is visible to the wearer 601 acquiring the operation visual field 501; specify a visible range on the display region 502; specify the operation visual field 501 and the display region 502 based on this visible range; and specify a positional relationship between the operation visual field 501 and the display region 502.

The above description has assumed the example where the marks are sequentially displayed on the display region 502, but is not limited to this. Marks (for example, numbers) that are different depending on where they are positioned in the display region 502 may be displayed all together, and the wearers 601 may state only the visible marks. In the display region 502, a part displaying a mark visible to the wearer 601 is defined by the control circuit 110, as a part of the display region 502 included in the operation visual field 501.

As described above, the control circuit 110 functions as an operation visible field-display region specifying unit configured to: cause the display part 136 to present different displays in different positions all together; acquire information from the wearer 601 regarding a visible display out of the different displays; and specify a visible range in the display region 502.

In addition, a positional relationship between the operation visual field 501 and the display region 502 may be specified as described below. Even if the display region 502 is located outside of the operation visual field 501, it is important to have information on how far the display region 502 is apart from the visual field in order to know the fact that an eye direction is different between a time when an operation is performed and a time when a display is checked. This difference in direction can be determined by displaying what is seen in the approximate center of the operation visual field 501 when the display region 502 is seen. That is, the wearer 601 as an operator memorizes what he or she sees in the center when performing an operation. Thereafter, when shifting the line of sight to the display part 136 to see what is displayed thereon, the wearer 601 reports that he or she has seen the same. This report may be performed by any method, for example, by an input in response to some kind of reaction. This report enables a control unit such as the control circuit 110, or this system to specify a positional relationship between the operation visual field 501 and the display region 502.

During an operation, when the camera 140 performs imaging and the wearer 601 checks the display part 136, the display part 136 is caused to display a part of a shot image, and then to sequentially switch to display parts of the shot image. The wearer 601 can recognize that what was seen during the operation is gradually displayed on the display part 136. The wearer 601 inputs timing when what was seen during the operation matches what is displayed on the display part 136. This enables a determination of parallax information necessary to match what was seen in the center when an operation is performed with what is displayed when the display is checked. Parallax information includes a difference in the line of sight between a time when an operation is performed and a time when what is displayed on the display part 136 is checked. In FIG. 3, this parallax corresponds to the parallax θ1 in a direction between the line of sight in the operation visual field of the wearer 601, presented by the solid-line arrow 511, and the line of sight of the wearer 601 viewing the center of the display part 136, presented by the dashed-dotted-line arrow 521.

A determination result regarding this parallax is specified by the image processing circuit 126 (in particular, the operation visible field-display region specifying unit) and is stored in the storage device 124. In this manner, the wearer 601 of the wearable device 100 (terminal), or a person or device who or which determines an image provided from the camera of the wearable device 100, can determine which part was seen by the wearer 601 during an operation.

For processing described above, the following is performed in the processing shown in the flowchart of FIG. 7, for example. In step S205, the control circuit 110 outputs a sound requesting the wearer 601 to memorize the view in the center of the operation visual field, then shift the line of sight to the display part 136, and state the fact when the same visual field as the memorized operation visual field is displayed on the display part 136. In step S206, the control circuit 110 causes the image processing circuit 126 to extract various parts from the image that was acquired by the camera 140 in step S203 when the wearer 601 was acquiring the operation visual field, and causes the display part 136 to display the extracted parts of the image. The control circuit 110 sequentially changes what is displayed by changing where to extract, and acquires the speech of the wearer 601 at that time. When recognizing that the wearer 601 states that he or he “sees”, in step S207, the control circuit 110 specifies a positional relationship between the display region 502 and the operation visual field 501 based on a relationship between which part of the image acquired by the camera 140 is extracted and displayed on the display part 136, and which part of the image acquired by the camera 140 was seen in the center when the wearer 601 acquired the operation visual field specified in step S204. For example, as shown in FIG. 8, in the case where a heart mark was seen in the center of the operation visual field 501, the wearer 601 states that he or she “sees” the heart mark when it is displayed in the center of the display part 136.

As stated, it becomes possible to provide the wearable device 100 that further includes an image acquisition unit, a display control unit, and an operation visual field-display region specifying unit. The image acquisition unit acquires an image shot when the wearer 601 is acquiring the operation visual field. The display control unit controls what is displayed on the display part 136 so that parts of the shot image are sequentially extracted and displayed. When parts of the shot image are sequentially extracted and displayed, the operation visual field-display region specifying unit specifies a positional relationship between the operation visual field 501 and the display region 502 by acquiring a result of the determination by the wearer 601 when he or she visually checks the display part 136 and sees thereon the image feature that was seen in the approximate center of the operation visual field 501. Herein, in order to make the wearer 601 have the aforementioned operation visual field, a guide message presenting “acquire an operation visual field” may be issued. Furthermore, in order to make the wearer 601 visually check the display part 136 as described above, a guide message presenting “look at the display unit” may be issued. In the case of sequential display, the aforementioned determination result may include a relation between timing of such display and an entry such as “able to see now”, “which one was seen”, or “which pattern was seen”.

In addition, a positional relationship between the operation visual field 501 and the display region 502 may be specified as described below. That is, information regarding what is seen by the wearer 601 in a condition where his or her line of sight has been shifted to the display part 136 can be acquired. This information includes information on an image feature of a subject seen by the wearer 601, such as a name, shape, or color, which is distinct from the surroundings. The image processing circuit 126 detects a corresponding image feature from an image acquired by the camera 140. Based on this detection result as well, a parallax between the line of sight of the wearer 601 when viewing the display part 136 and the optical axis of the camera 140 may be specified. As a result, the parallax θ1 between the line of sight in the operation visual field of the wearer 601 and the line of sight when the wearer 601 views the display part 136 may also be acquired.

In step S208, the control circuit 110 causes the storage device 124 to record a positional relationship between the imaging region 503 and the operation visual field 501 specified in step S204 and a positional relationship between the display region 502 and the operation visual field 501, specified in step S207.

As described above, a positional relationship between the operation visual field 501, the display region 502, and the imaging region 503 is specified and stored in the storage device 124, and then the calibration processing is terminated. A positional relationship to be specified may correspond to, for example, the parallax θ1 between the line of sight in the operation visual field of the wearer 601 and the line of sight of the wearer 601 viewing the display part 136, the parallax θ2 between the line of sight in the operation visual field of the wearer 601 and the optical axis of the camera 140, etc.

<Usage Example of Wearable Device>

Some examples of the utilization processing that is performed in step S106 will be described with reference to the drawings.

### First Example

In the first example, while the wearer 601 performs a specific operation, the display part 136 of the wearable device 100 displays procedures of this operation. The wearer 601 can perform the operation with reference to the procedures displayed on the display part 136. In this example, the wearable device 100 establishes no communications with any external device during an operation and analyzes the operation that is performed by the wearer 601, based on information stored in the storage device 124 of the wearable device 100.

In step S301, the control circuit 110 performs an operation setting with respect to, e.g., operation procedures. For example, the wearer 601 operates the input device 184, etc. while viewing a menu screen displayed on the display part 136, thereby inputting a to-be-performed operation in the wearable device 100. The control circuit 110 that has acquired information on a type of operation, etc. performs various operation-related settings based on information stored in the storage device 124. For example, the control circuit 110 reads out of the storage device 124, information on procedures of a selected operation, criteria to determine progress of this operation, etc. In operation settings, the wearable device 100 may communicate with, e.g., the server 310 to acquire information relevant to operation settings from the server 310.

In step S302, the control circuit 110 acquires an image in the direction of the line of sight of the wearer 601 by causing the camera 140 to perform imaging. In step S303, the control circuit 110 analyzes the acquired image, thereby analyzing an operation that the wearer 601 is currently performing. This analysis includes, e.g., a determination of whether or not the wearer 601 is performing an operation in accordance with the operation procedures set in step S301, or a determination of the necessity to complete one of the operation procedures and proceed to a next procedure. This analysis may utilize a positional relationship between the operation visual field 501 and the imaging region 503, specified in the calibration processing. For example, in the acquired image, a range corresponding to the operation visual field 501 may be set to an analysis target.

In step S304, the control circuit 110 determines, based on a result of the aforementioned analysis, the necessity to update a procedure displayed on the display part 136. If there is no necessity to update an operation procedure, the processing proceeds to step S306. On the other hand, if there is a necessity to update an operation procedure, the processing proceeds to step S305. In step S305, the control circuit 110 causes the display element 131 to display an image relating to an operation procedure in accordance with a condition. Subsequently, the processing proceeds to step S306. Display may be performed in combination with sound using the speaker 154 or vibration using the vibrator 164, etc.

In step S306, the control circuit 110 determines whether the wearer 601 needs to be alerted. An alert is determined to be necessary, for example, when it turns out as a result of condition analysis that the wearer 601 has made a mistaken operation procedure. If an alert is not necessary, the processing proceeds to step S310. On the other hand, if an alert is necessary, the processing proceeds to step S307.

In step S307, the control circuit 110 determines whether the display region 502 is sufficiently inside the operation visual field 501 by referring to a positional relationship specified in the calibration processing. For example, the control circuit 110 determines whether the display region 502 is sufficiently inside the operation visual field 501, based on whether a value that indicates how far the operation visual field 501 and the display region 502 are apart from each other, such as a difference in a center position between the display region 502 and the operation visual field 501, a ratio of a part overlapping with the operation visual field 501 to the display region 502, etc., is smaller than a predetermined value. When the display region 502 is included in the operation visual field 501, the processing proceeds to step S309. On the other hand, when the display region 502 is not inside the operation visual field 501, the processing proceeds to step S308.

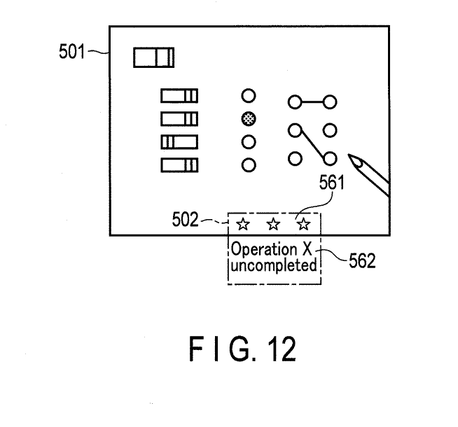

FIG. 12 shows one example of the operation visual field 501 and the display region 502 in the case where the display region 502 is not inside the operation visual field 501. The wearer 601 performs an operation while viewing the inside of the operation visual field 501. At this time, assume that the wearer 601 shifts to a next operation without completing operation X. The control circuit 110 specifies such a situation as happening based on an image acquired by the camera 140. At this time, the wearable device 100 causes the display part 136 to display a message 562 to alert the wearer 601, for example, a message such as “operation X incomplete”. In the example shown in FIG. 12, the display region 502 of the display part 136 is mostly located outside the operation visual field 501. Thus, even if a message is simply displayed on the display part 136, there is a risk that the wearer 601 will not notice such a message. Considering such a risk, the wearable device 100 according to the present embodiment provides a warning by a vibration, sound, or display.

That is, in step S308, the control circuit 110 causes the vibrator drive circuit 162 to vibrate the vibrator 164. Alternatively, the control circuit 110 causes the sound output circuit 152 to generate warning a sound via the speaker 154. Alternatively, as shown in FIG. 12, for example, the control circuit 110 causes the display element 131 to display, bright points 561, etc. in parts of the display region 502, which are included in the operation visual field 501. With these warnings, the wearer 601 is expected to shift the line of sight in the direction of the display part 136. In the case where the display region 502 is not included at all in the operation visual field 501, a warning cannot be provided using the display. After the processing in step S308, the processing proceeds to step S309.

In step S309, the control circuit 110 causes the display element 131 to display the message 562 relevant to an alert. The wearer 601 who saw this message 562 is expected to perform a correct operation. For example, in the above example, the wearer 601 is expected to return to operation X. For example, when a predetermine time elapses after display of the message 562 on the display part 136, the processing proceeds to step S310. If a display time is long enough, the display operation in step S309 and the warning operation determined to be necessary in steps S307 and S308 may be performed in reverse order.

In step S310, the control circuit 110 determines whether to terminate the processing. The control circuit 110 determines a termination of the processing, for example, when the wearer 601 turns the wearable device 100 off, or when a predetermined operation set based on a shot image is determined to be completed. The processing returns to step S302, if not terminated. That is, the wearable device 100 repeats performing imaging by using the camera 140 and condition analysis based on a shot image, thereby updating display of an operation procedure or giving an alert. If a termination is determined in step S310, this processing is terminated.

According to this example, the wearer 601 who is wearing the wearable device 100 can perform an operation while checking procedures of the current operation via a display on the display part 136 located in a part of the visual field. At this time, the wearer 601 can use his or her hands freely because the wearable device 100 is worn on the wearer's face. The display part 136 of the wearable device 100 does not cover the wearer's visual field, so that the wearer 601 can ensure the visual field necessary for an operation.

In addition, even if the wearer 601 makes a procedure mistake in the current operation, the display part 136 displays this fact. Therefore, the wearer 601 can correct the operation procedure without making a major mistake. In this example, depending on whether the display region 502 is included in the operation visual field 501, the way of alerting the wearer 601 who is making an operation procedure mistake is switched between simple display of an alert on the display region 502 and display of an alert in combination of a warning by a vibration, sound, or display if possible, for guiding the line of sight of the wearer 601. Even if the display region 502 is located outside the operation visual field 501, when an operation runs smoothly, the wearer 601 shifts the line of sight based on his or her demand in the direction of the display region 502. There is no particular need to urge the wearer 601 to shift the line of sight to the display region 502. On the other hand, when an alert becomes necessary when, for example, there is a mistake in performing an operation, the wearer 601 needs to check the message 562 to be displayed on the display region 502. For this, it is necessary to guide the line of sight of the wearer 601 to the display region 502. Therefore, the present embodiment adopts a warning using vibration, sound, display, etc.

In the example described above, a display position of an image may be adjusted by changing a position of the image to be displayed on the display element 131, in accordance with a positional relationship between the operation visual field 501 and the display region 502. With such an adjustment, an image in an operation visual field can always be displayed in the optimal position.

The example described above has assumed the example where a condition analysis is made based on an image shot by the camera 140, but is not limited to this. Condition analysis may be made using information acquired from any device used in an operation, in place of or in addition to an image shot by the camera 140. For example, in the case where a torque wrench for measuring torque is used in an operation, torque information acquired from this torque wrench may be used for condition analysis.

### Second Example

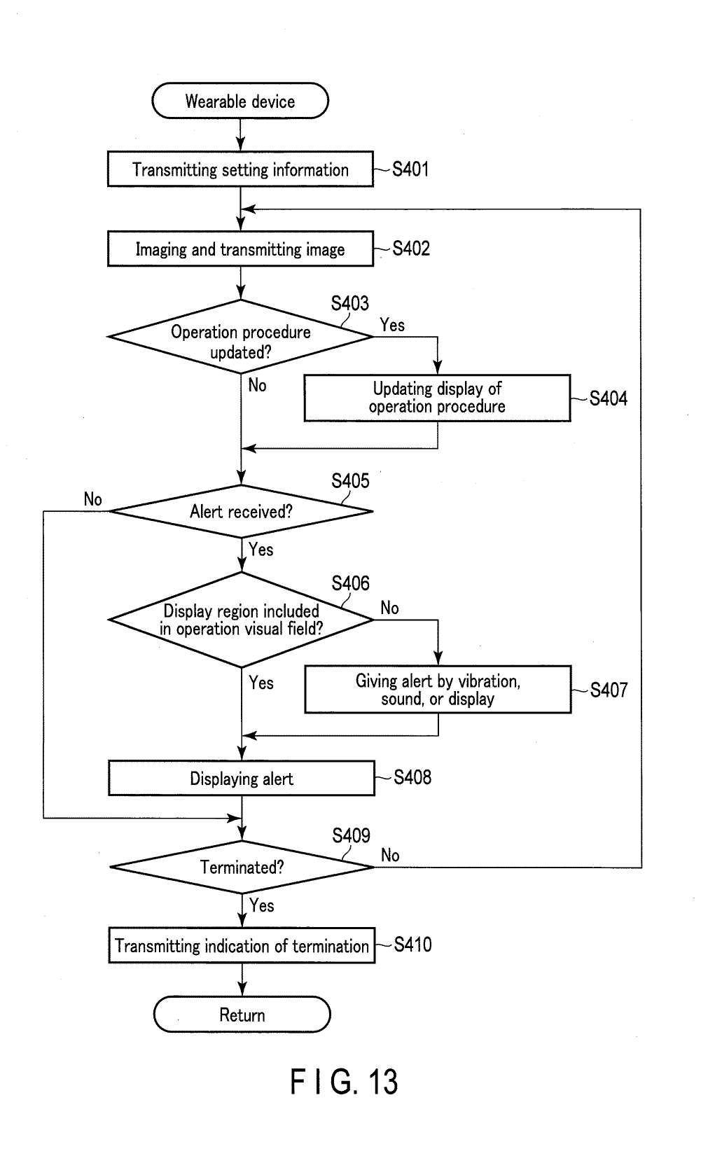

In the first example, the wearable device 100 performs condition analysis, a determination of an operation procedure to present, etc. On the other hand, in the second example, the wearable device 100 communicates with the server 310, and the server 310 performs those condition analyses and determinations, etc. The operation of the wearable device 100 according to the second example will be described with reference to the flowchart shown in FIG. 13.

In step S401, the control circuit 110 transmits setting information to the server 310. That is, for example, the wearer 601 operates the input device 184, etc. while viewing a menu screen displayed on the display part 136, thereby inputting a to-be-performed operation in the wearable device 100. The control circuit 110, which has acquired information relevant to a type of operation, transmits the acquired information to the server 310 via the communication circuit 190.

In step S402, the control circuit 110 causes the camera 140 to perform imaging in the direction of the line of sight of the wearer 601 and acquires the shot image. The control circuit 110 transmits the acquired image to the server 310 via the communication circuit 190. The server 310 performs various types of analyses, determinations, etc. based on information received from the wearable device 100, thereby transmitting results to the wearable device 100. The wearable device 100 performs various operations based on the information acquired from the server 310.

In step S403, the control circuit 110 determines whether a signal instructing update of an operation procedure displayed on the display part 136 is received from the server 310. In the case of not receiving information instructing an update of a displayed operation procedure, the processing proceeds to step S405. On the other hand, when an update of a displayed operation procedure is instructed, the processing proceeds to step S404. In step S404, the control circuit 110 updates an operation procedure displayed on the display part 136, based on information received from the server 310. Subsequently, the processing proceeds to step S405.

In step S405, the control circuit 110 determines whether a signal instructing display of an alert is received from the server 310. In the case of not receiving a signal instructing display of an alert, the processing proceeds to step S409. On the other hand, in the case of receiving a signal instructing display of an alert, the processing proceeds to step S406.

In step S406, the control circuit 110 determines whether the display region 502 is included in the operation visual field 501. When the display region 502 is included in the operation visual field 501, the processing proceeds to step S408. On the other hand, when the display region 502 is not included in the operation visual field 501, the processing proceeds to step S407. In step S407, the control circuit 110 provides the wearer 601 with a warning by a vibration, sound, or display. Subsequently, the processing proceeds to step S408.

In step S408, the control circuit 110 causes the display part 136 to display an alert, based on information received from the server 310. For example, after an alert is displayed for a predetermined time of period, the processing proceeds to step S409.

In step S409, the control circuit 110 determines whether to terminate the processing. The processing returns to step S402, if not terminated. If the processing is determined to be terminated, the processing proceeds to step S410. In step S410, the control circuit 110 transmits information indicative of termination of the processing to the server 310, thereby terminating this processing.

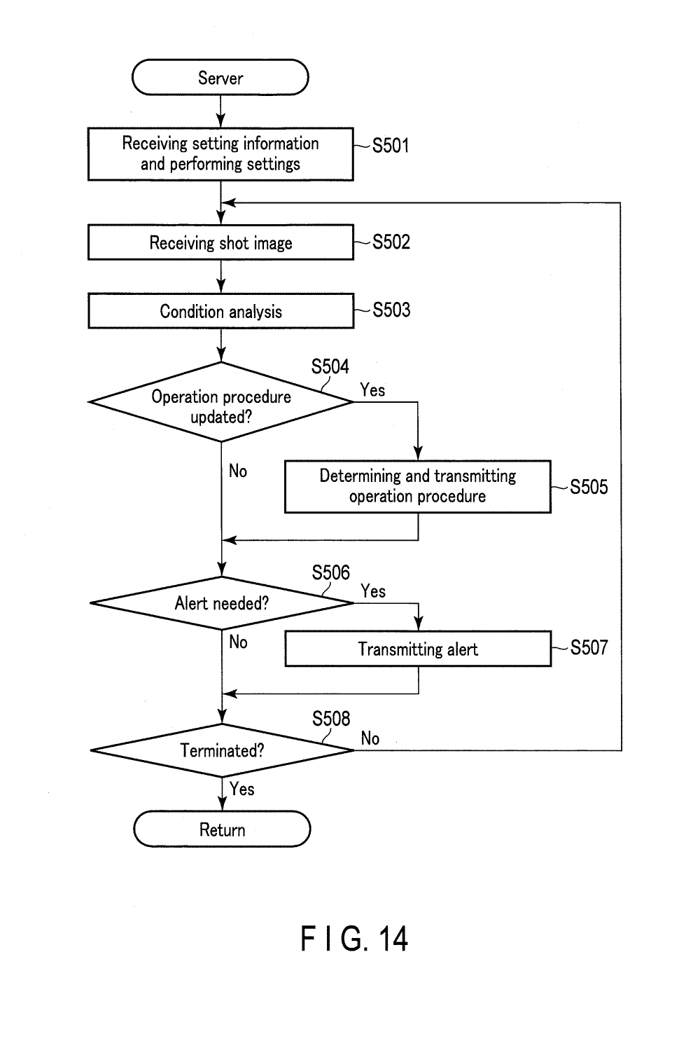

While the wearable device 100 performs the above-described processing, the server 310 operates in connection with this processing. Such operation of the server 310 will be described below with reference to the flowchart shown in FIG. 14.

In step S501, the processor 311 of the server 310 receives setting information transmitted from the wearable device 100 in step S401 described above. Based on the received setting information, the processor 311 performs various settings for, e.g., procedures of an operation that the wearer 601 of the wearable device 100 is about to perform.

In step S502, the processor 311 receives a shot image which is transmitted from the wearable device 100 in step S402 described above. In step S503, the processor 311 analyzes a condition of an operation to be performed by the wearer 601, based on the received shot image. This analysis may utilize a positional relationship between the operation visual field 501 and the imaging region 503, specified in the calibration processing.

In step S504, the processor 311 determines based on the analysis result whether or not to update an operation procedure which the wearable device 100 is made to display. If update of an operation procedure is unnecessary, the processing proceeds to step S506. On the other hand, if update of an operation procedure is determined to be necessary, the processing proceeds to step S505. In step S505, the processor 311 determines an operation procedure to be displayed on the wearable device 100, and transmits to the wearable device 100, information relevant to this operation procedure including information on a screen to be displayed on the wearable device 100. Subsequently, the processing proceeds to step S506. The wearable device 100 that has acquired the aforementioned information updates an operation procedure to be displayed based on this information on the display part 136 in step S404.

In step S506, the processor 311 determines based on the analysis result whether or not the wearer 601 needs to be alerted. If an alert is not necessary, the processing proceeds to step S508. On the other hand, if an alert is determined to be necessary, the processing proceeds to step S507. In step S507, the processor 311 transmits to the wearable device 100, information relevant to an alert, such as information relevant to the message 562 to be displayed on the display part 136. Subsequently, the processing proceeds to step S508. The wearable device 100 that has received this information relevant to an alert displays an alert based on the processing from step S406 to S408.

In step S508, the processor 311 determines whether or not an indication of terminating the processing is received from the wearable device 100, and determines whether or not to terminate the processing. If it is determined that the processing is not terminated, the processing returns to step S502. On the other hand, if a termination is determined, this processing is terminated.

As described above, the wearable device 100 according to the second example can also perform the same operation of the first example as the operation which appears to the wearer 601. With the wearable device 100 according to the second example, an operation requiring a large amount of calculation can be performed by an external device. As a result, the wearable device 100 according to the second example saves more power and becomes smaller than the wearable device 100 which performs all processing by itself.

### Third Example

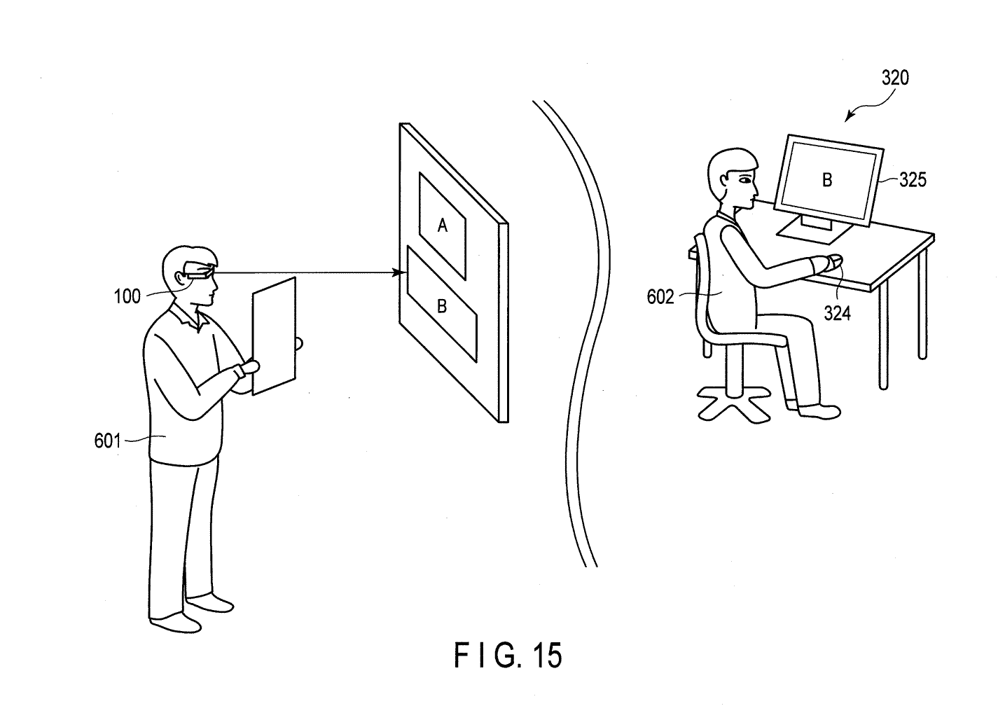

In the first and second examples, the wearable device 100 presents predetermined operation procedures to the wearer 601. In contrast, in the third example, the wearable device 100 causes the display part 136 to display instructions from an instructor 602 who operates the information terminal 320 in a remote location. FIG. 15 is a schematic diagram showing a usage state of the system 1 according to the third example. The wearer 601 who is wearing the wearable device 100 performs a predetermined operation. The wearable device 100 performs imaging in the line of sight of the wearer 601, and transmits a shot image to the information terminal 320. The information terminal 320 causes the display device 325 thereof to display an image relevant to an operation visual field of the wearer 601. The instructor 602 checks a state of the operation by the wearer 601, while viewing the image displayed on the display device 325. The instructor 602 operates the input device 324 of the information terminal 320 as needed, thereby transmitting various instructions to the wearable device 100. The wearable device 100 causes the display part 136 to display the received instructions.

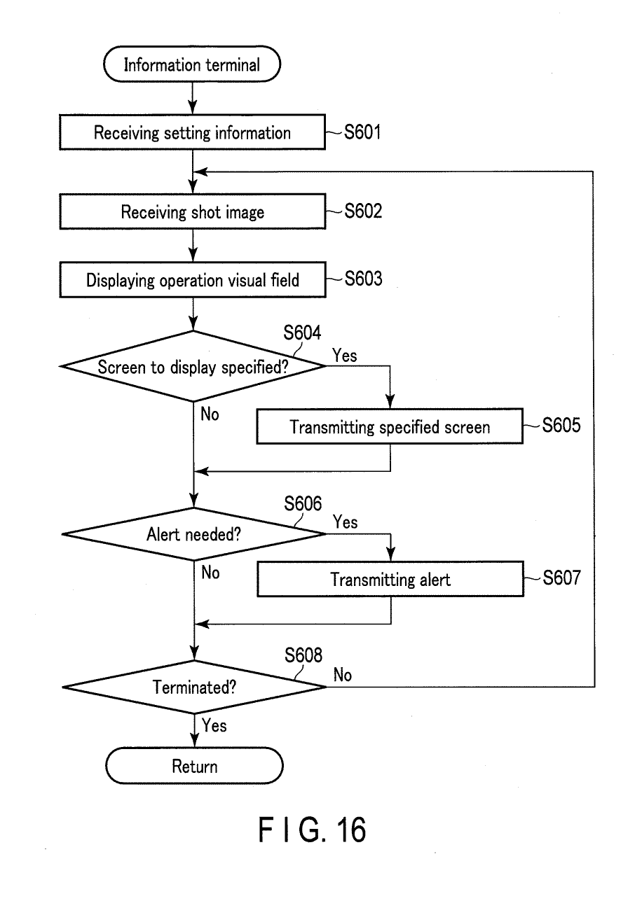

The wearable device 100 according to the third example also operates to perform the similar processing to that described above with reference to FIG. 13. The processing that the information terminal 320 performs at that time will be described with reference to the flowchart shown in FIG. 16.

In step S601, the processor 311 of the information terminal 320 receives setting information which is transmitted from the wearable device 100 in step S401 described above. The processor 321 performs various settings based on the received setting information. In this example, the information transmitted from the wearable device 100 includes information indicative of a relation between the operation visual field 501 and the imaging region 503.

In step S602, the processor 321 receives a shot image which is transmitted from the wearable device 100 in step S402 described above. In step S603, based on the received shot image, the processor 321 trims the imaging region 503 to cut out its range included in the operation visual field 501, thereby causing the display device 325 to display this range. The above step uses a relation between the imaging region 503 and the operation visual field 501, which is determined by the wearable device 100 and received therefrom. This trimming may be performed by the wearable device 100. These measures are undertaken because it is easier to communicate when a remote third party can get a grip on what is seen by an operator during an operation. Therefore, as long as what is seen by the operator is clear from what is displayed, trimming is not necessarily performed. In addition, due to a position gap (parallax) between the camera and the operator's eyes, the influence from such a gap may be unable to be ignored in the case of a close distance. In such a case, trimming or similar countermeasures are performed for display in consideration of distance information, etc.

In step S604, the processor 321 determines whether or not a screen to be displayed on the wearable device 100 is specified by the instructor 602. If a screen is not specified, the processing proceeds to step S606. On the other hand, if a screen is specified, the processing proceeds to step S605. In step S605, the processor 321 specifies a screen to be displayed on the wearable device 100, and transmits information relevant to this screen to the wearable device 100. Subsequently, the processing proceeds to step S606. Based on the received information, the wearable device 100 displays a specified screen on the display part 136 in step S404. In addition to information on what is displayed on the screen, information on the speech of the instructor 602, etc. may also be transmitted from the information terminal 320 to the wearable device 100 and then to the wearer 601.

In step S606, the processor 321 determines whether the instructor 602 inputs an indication of alerting the wearer 601 using the wearable device 100. If no alert is given, the processing proceeds to step S608. On the other hand, if an alert is given, the processing proceeds to step S607. In step S607, based on an input by the instructor 602, the processor 321 transmits to the wearable device 100, information relevant to an alert, such as information relevant to the message 562 to be displayed on the display part 136. Subsequently, the processing proceeds to step S608. The wearable device 100 that has received this information relevant to an alert displays an alert based on the processing from step S406 to S408.

In step S608, the processor 321 determines whether or not an indication of terminating the processing is received from the wearable device 100, and determines whether or not to terminate the processing. If it is determined that the processing is not terminated, the processing returns to step S602. On the other hand, if a termination is determined, this processing is terminated.

According to the third example, even if the wearer 601 who performs an operation is away from the instructor 602 who gives instructions on the operation, they can share information such as a visual field of the wearer 601, operational instructions, etc. With the usage of this system 1, even in a condition where a work site is too remote to dispatch a large number of experts, various operations can be performed by an on-site operator who wears the wearable device 100 and one or more instructors 602 as, for example, an expert, who are at a location away from the site. Since a positional relationship is specified in advance between the operation visual field 501 and the imaging region 503, the display device 325 of the information terminal 320 can accurately display a visual field recognized by the wearer 601.

### Fourth Example

Unlike the first to third examples, the fourth example relates to an augmented reality (AR) using the wearable device 100. The display part 136 of the wearable device 100 is caused to present a predetermined display in accordance with the real world that the wearer 601 is actually seeing. In this manner, the wearer 601 recognizes a world in which an image displayed by the wearable device 100 is added to the real world that is actually being seen.

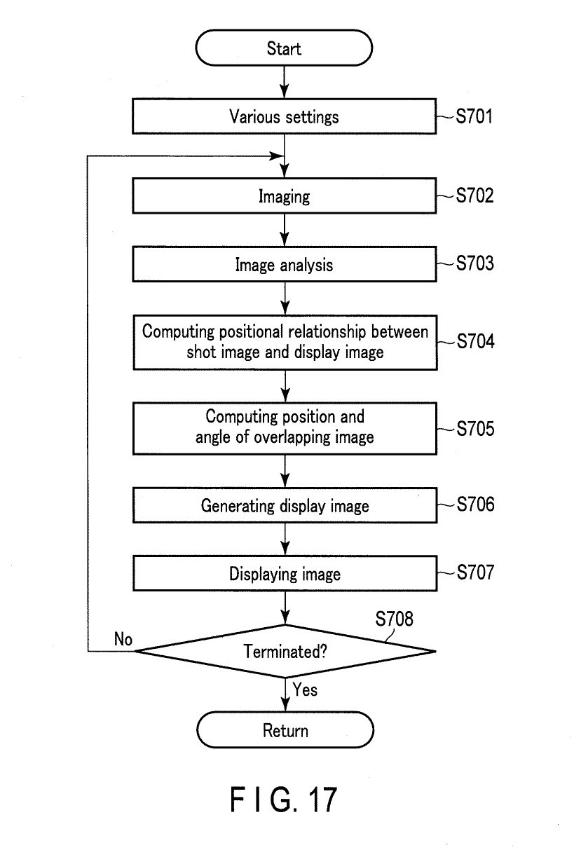

The operation of the wearable device 100 in this example will be described with reference to the flowchart shown in FIG. 17. The following description assumes the example where the wearable device 100 performs processing independently; however, part of the processing may be performed by an external device such as the server 310 as in the second example. Furthermore, as in the third example, a display on the display part 136 may be performed based on a command from the information terminal 320 that is operated by another person.

In step S701, the control circuit 110 performs various settings relevant to an augmented reality. The settings include a setting to determine what to display and where to display by using the display element 131.

In step S702, the control circuit 110 acquires an image by causing the camera 140 to perform imaging. In step S703, the control circuit 110 analyzes the acquired shot image. This image analysis includes analysis of a subject to determine what subject is shot in the image and which part of the image contains the subject.

In step S704, the control circuit 110 performs computation regarding alignment between the shot image and a display image to be displayed on the display part 136, based on a positional relationship between the imaging region 503 and the display region 502.

In step S705, the control circuit 110 determines an object which is not present in the real world and is to be displayed on the display part 136, based on the analysis result of the shot image, and performs computation regarding, for example, a position to display the object, and an angle of the object to be displayed, etc.

In step S706, the control circuit 110 generates an image to be displayed on the display element 131, based on, e.g., the computation results acquired through steps S703 to S705. In step S707, the control circuit 110 causes the display element 131 to display the generated image.

In step S708, the control circuit 110 determines whether to terminate the processing, and repeats the processing from step S702 to S707 until a termination of the processing is determined. If a termination is determined, the processing is terminated.

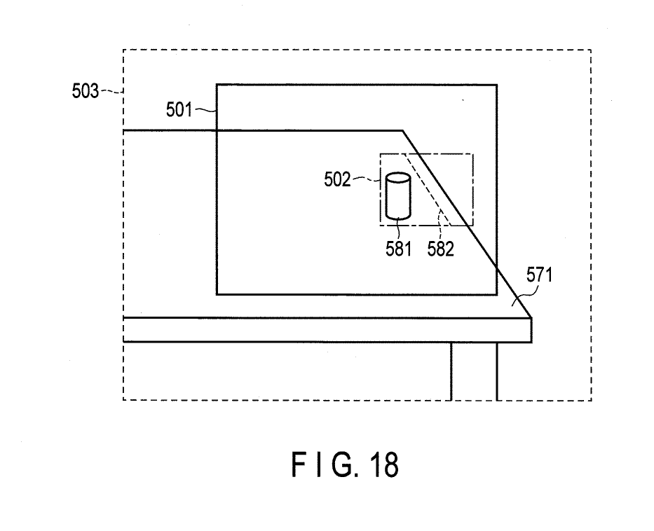

An example of what is visually recognized by the wearer 601 in this example will be described with reference to the schematic diagram shown in FIG. 18. In the example shown in FIG. 18, the display region 502 is included in the operation visual field 501 of the wearer 601. The imaging region 503 is larger than the operation visual field 501 to include the entire region thereof. In the example shown in FIG. 18, the wearer 601 is looking in the direction of a desk 571. In this example, a virtual object 581 is displayed on the desk 571 which actually exists, by using the display unit 102. Furthermore, in this example, a broken line 582 is displayed in a position with a predetermined distance from the edge of the desk 571. The broken line 582 indicates that anything should be placed inside this position.

Positions of the object 581 and the broken line 582 are determined based on a position of the edge of the desk 571, which is specified by image analysis in step S703, computation regarding a positional relationship determined in step S704, and so on. An angle of the object 581, etc. is determined based on an angle of the desk 571, which is specified by image analysis in step S703, computation performed in step S705, and so on. Based on results of the above, an appropriate image is generated in step S706.

Display may be configured in a manner so that, for example, the image displayed on the display part 136 includes only the object 581 and the broken line 582, and the desk 571 is viewed as the real world that is seen through the display part 136. Furthermore, display on the display part 136 may be configured in a manner to form an image presenting the overall display region 502 that includes not only the object 581 and the broken line 582, but also the desk 571 aligned to the real desk 571.

According to the fourth example, an augmented reality using the wearable device 100 can be realized. Since a positional relationship is specified between the operation visual field 501, the display region 502, and the imaging region 503, appropriate alignment can be achieved between a position of a real object and a position of a virtual object to be displayed on the display part 136.

### Other Examples

The wearable device 100 is usable for displaying various types of information without limitation to the first to fourth examples. For example, the wearable device 100 may display a schedule registered by the wearer 601, emails, and so on. The wearable device 100 may bear a display function of a smartphone that the wearer 601 carries.

The wearable device 100 can prompt the wearer 601 to direct his or her line of sight toward the display region 502 in accordance with, for example, a positional relationship between a visual field of the wearer 601 and the display region 502, by a sound, vibration, display, etc., as necessary. For example, if the display region 502 is located outside a visual field when an email is received, the wearable device 100 can prompt the wearer 601 to direct his or her line of sight toward the display region 502.

Furthermore, the wearable device 100 is usable as a camera to image what is seen by the wearer 601. The wearable device 100 can generate an image in accordance with a visual field of the wearer 601 in consideration of a line of sight of the wearer 601 and the optical axis of the camera optical system 145 when imaging is performed.

The above description has assumed the case where an image is guided by light guiding to the display part 136 that is smaller in size than the pupil diameter of the wearer 601, thereby being arranged in front of the wearer's eyes. However, the description is not limited to this. The light guiding unit 137 may not be provided. Furthermore, the display part 136 may be large in size or a display range may be limited. From the viewpoint of detection of a parallax between the operation visual field 501 and a device or the like, the technique described above is adoptable for an operation in which a positional relationship between a wearer and a device comes into a particular condition. The display device or the camera may be separate from a main device.

### MODIFICATIONS

Modifications of the wearable device 100 according to the present embodiment will be described.

The wearable device 100 may further include a line of sight sensor that specifies a line of sight of the wearer 601. The line of sight sensor is, for example, an image sensor incorporated in the display unit 102, and images a position of eyes of the wearer 601 using the display optical system. For example, the control circuit 110 specifies a direction of a line of sight of the wearer 601 based on the acquired image indicative of a position of the eyes.

With the use of the wearable device 100 including the line of sight sensor, the operation visual field 501 in the above embodiment, which is changeable, can be specified in accordance with a moment-to-moment line of sight. This results in improved applicability and accuracy of respective operations in the above embodiment.

Furthermore, in the above embodiments, when the wearer 601 is required to cast his or her line of sight to the display part 136 because the display region 502 is located outside the operation visual field 501, the wearer 601 is alerted by a sound, vibration, display, etc. Alternatively, the wearable device 100 may include an actuator configured to change a position of the display unit 102. That is, the wearable device 100 may have a mechanism to change a position of the display part 136 in a manner to include the display region 502 in the operation visual field 501, when the wearer 601 is required to cast his or her visual site to the display part 136. This mechanism may adopt various types of actuators such as a bimorph, artificial muscle, motor, voice coil motor, etc.

Furthermore, the wearable device 100 may include a mechanism for moving the optical axis of the camera 140. With this mechanism, the wearable device 100 can change the imaging region 503 as appropriate. For example, it becomes possible to adjust the optical axis of the camera 140 in a manner so that the operation visual field 501 corresponds to the imaging region 503.

The embodiment described above has assumed the wearable device 100 including the camera 140, but is not limited to this. The wearable device 100 may include the display unit 102 without the camera 140.

Of the techniques described in each embodiment, the controls described using the flowcharts are realized as programs. The programs may be stored in a recording medium, a recording unit, etc. The programs can be recorded in the recording medium or recording unit in various ways. They may be recorded at the time of shipping a product, they can be recorded using a distributed recording medium, or they can be downloaded from the Internet. The functions similar to the above controls may be realized by artificial intelligence composed by deep learning, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wearable device comprising:
a display element that displays an image based on an image signal;
a display part that is configured to be arranged in front of an eye of wearer, has a narrower display region than a visual field of the wearer, and displays the image displayed on the display element and guided by a light guiding optical system; and
a storage device that stores a positional relationship between an operation visual field as a visual field of the wearer in performing an operation, and the display region of the display part arranged in front of the eye.

2. The wearable device according to claim 1, wherein the display part is smaller in size than a pupil diameter of the wearer.

3. The wearable device according to claim 1, wherein an alert is given by a sound, vibration, or display if a value indicating how far the operation visual field and the display region are apart from each other is greater than a predetermined value, and a line of sight of the wearer needs to be guided to the display part.

4. The wearable device according to claim 1, further comprising a camera that performs imaging in a direction of a visual field of the wearer, wherein the storage device stores as the positional relationship, a positional relationship between the operation visual field, the display region, and an imaging region for the camera.

5. The wearable device according to claim 4, further comprising an image processing circuit that trims an image shot by the camera in accordance with the operation visual field.

6. The wearable device according to claim 4, wherein the display element adjusts a display position of the image in accordance with a positional relationship between the imaging region and the display region.

7. The wearable device according to claim 4, further comprising:
an image processing circuit configured to:
acquire information on a feature of an image which the wearer sees in a predetermined position inside the operation visual field when the wearer is having the operation visual field, and
specify a position of a subject inside the imaging region based on an image feature recognition with respect to an image acquired using the camera; and
a control circuit configured to specify the positional relationship between the operation visual field and the imaging region based on the position of the subject.

8. The wearable device according to claim 7, wherein the control circuit is configured to specify the positional relationship by specifying the operation visual field in the image based on the position of the subject and a size of the operation visual field.

9. The wearable device according to claim 7, wherein the control circuit is configured to specify the positional relationship by specifying a plurality of positions indicative of the operation visual field, as a position of the subject, and specifying the operation visual field in the image based on the plurality of positions.

10. The wearable device according to claim 1, further comprising a control circuit configured to:
control a display on the display part;
acquire a result of a determination by the wearer regarding whether a display on each part of the display part is visible to the wearer having the operation visual field, and specify the operation visual field and the display region based on a visible range of the display region;
specify the positional relationship between the operation visual field and the display region; and
cause the storage device to store the specified positional relationship.

11. The wearable device according to claim 10, wherein the control circuit is configured to:
cause the display part to sequentially display predetermined displays in different positions;
sequentially acquire results of determinations regarding whether the displays are visible to the wearer; and
specify a visible range in the display region.

12. The wearable device according to claim 10, wherein the control circuit is configured to:
cause the display part to display different displays in different positions all together; and
specify the visible range in the display region by acquiring information indicated by the wearer, regarding a visible display of the different displays.

13. The wearable device according to claim 4, further comprising a control circuit configured to:
acquire a shot image when the wearer is having an operation visual field;
sequentially extract parts of the shot image and cause the display part to display the parts; and
specify the positional relationship between the operation visual field and the display region by acquiring a result of a determination by the wearer that a feature of an image, which the wearer has seen in a center of the operation visual field, is seen by the wearer on the display part in a condition of viewing the display part when the parts of the shot image are sequentially extracted and displayed.

14. The wearable device according to claim 1, wherein the display element adjusts a display position of the image in accordance with a positional relationship between the operation visual field and the display region.

15. The wearable device according to claim 1, further comprising a communication circuit for enabling a communication with an external device, wherein the positional relationship is transmitted to the external device via the communication circuit.

16. A control method for a wearable device, comprising:
displaying an image based on an image signal on a display part that is configured to be arranged in front of an eye of wearer, and has a narrower display region than a visual field of the wearer; and
storing a positional relationship between an operation visual field as a visual field of the wearer in performing an operation, and the display region of the display part arranged in front of the eye.
